(19) United States
(12) Patent Application Publication
(10) Pub. No.: US 2021/0186672 A1
(43) Pub. Date: Jun. 24, 2021

(54) APPARATUS AND METHOD FOR APPLYING MEDICANTS

(71) Applicant: Angela Wandera, Eden Prarie, MN (US)

(72) Inventor: Angela Wandera, Eden Prarie, MN (US)

(21) Appl. No.: 17/109,957

(22) Filed: Dec. 2, 2020

Related U.S. Application Data
(60) Provisional application No. 62/942,397, filed on Dec. 2, 2019.

(51) Int. Cl. A61C 19/06

(52) U.S. Cl. CPC A61C 19/066

(57) ABSTRACT

An apparatus for applying a medicant includes a carrier, and a matrix of absorbent material or expandable fiber attached to the carrier. The apparatus can be used to provide a dental or medical treatment and includes placing a medicant on the matrix of material and moving the carrier and material carrying the medicant to a treatment location.

### CROSS-REFERENCE TO RELATED APPLICATION

This application claims the benefit of U.S. Provisional Patent Application No. 62/942,397 filed Dec. 2, 2019, the entire disclosure of each of which is hereby incorporated herein by reference.

### BACKGROUND OF THE INVENTION

Silver diamine fluoride (“SDF”)—Ag(NH3)2F—and its predecessor silver nitrate have been used by dentists around the world for decades to arrest dental caries or cavities. While other fluoride products are used to prevent caries, SDF is a breakthrough therapy as a first drug to treat severe early childhood caries.

SDF has antimicrobial and remineralization properties. The exact mechanism of action is not fully understood. However, researchers theorize that the carious lesions are arrested because cariogenic bacteria are killed by the silver compound, and fluoride ions strengthen the tooth. When SDF is applied to caries lesions, a precipitate of Ag3PO4 forms on the softened dentin. This black insoluble “crust” reduces the impact of acid challenges and increase dentin hardness. The literature suggests SDF can arrest up to 80 percent of lesions in primary teeth. Another very exciting finding is that patients who have received this treatment show an over 50 percent decrease in new lesions.

SDF is useful for arresting caries in young children who are unable to cooperate for convention restorative dental care, children with special needs, and those who are medically fragile. It can also be used to postpone conventional restorative care. Silver nitrate has been available for decades and SDF is a more recent introduction onto the dental scene. SDF first became available in the spring of 2015. Because SDF is so useful as a treatment, it is anticipated that more dental professionals will be employing this in treatment plans for their patients.

As noted above, SDF has the ability to retard or arrest the biologic decay process of dental caries. Generally, it requires periodic applications to be effective. The medication does have some challenges. It must be stored in a cool, dark place and it must be handled with care as silver ions will stain or turn anything it contacts black. Care must also be exercised with personnel, clothes and dental surfaces. For SDF application, all dental equipment involved in the procedure must be covered by an impermeable material and staff needs to take precautionary measures to protect their skin and clothing. Set-up time for procedures using SDF or silver nitrate take additional time.

In addition to protecting dental professionals, the patient must also be similarly protected. For example, petroleum jelly is applied on the tissues abutting the treatment sites to prevent staining of gums. Reflection of the lips and cheeks is also required to prevent stains on the patient's lips and cheeks. Clear SDF liquid is placed in a non-glass receptacle. The teeth are dried and the clear SDF liquid is painted onto the sites several times with intermittent air-drying. The solution is aqueous and hence can drip into and onto sites not planned for treatment.

Many times it is difficult to treat the very young since it is many times difficult to gain compliance. Children many times are just plain scared. Younger patients that have contact with the aqueous solution of SDF or silver nitrate may be more sensitive to the solution and irritation of the lips and tongue can be significant. Additionally, black staining can occur a significant time after application.

Suffice it to say, that the application apparatus and method currently used is time consuming, difficult to use and the procedure is rather cumbersome. In essence, age old dental practices are being used in these applications which have many disadvantages.

### SUMMARY OF THE INVENTION

The inventions disclosed include a plurality of intra-oral devices that carry medicaments/therapeutic agents to specific sites in the oral cavity. The intra-oral devices facilitate targeted delivery of SDF or silver nitrate to a specific oral site. The intra-oral devices minimize side effects on adjacent or abutting tissue. The intra-oral devices also optimize therapeutic effects of the agent carried by the intra-oral device.

Generally, the portion of the process includes manufacturing and shipping a plurality of parts. The portion of the process may also include other processes that will result in less logistics at the point of assembly, such as the manufacturing site. Use of the intra-oral devices improve agent delivery, minimize side effects, and reduce clinical time and resources required. More importantly, use of these intra-oral devices are easier on the patient thereby making client compliance easier and optimizing the therapeutic effects. The clients are more happy with the treatment and it is less worrisome for all patients—especially the young or those having special needs.

### DESCRIPTION OF THE FIGURES

FIG. 1 is a schematic view of a group several teeth, some of which are totally healthy and others that include different types of caries or cavities.

FIG. 2 is a top schematic view showing two teeth with an interproximal caries on each of the teeth, prior to treatment.

FIG. 3 is a top schematic view showing two teeth with an interproximal caries on each of the teeth being treated with an example embodiment shown in FIG. 4.

FIG. 4 is a schematic view of a silver nitride or silver diamine fluoride delivery treatment apparatus, according to an example embodiment.

FIG. 5 is a top view of another silver nitride or silver diamine fluoride delivery treatment apparatus, according to an example embodiment.

FIG. 6 is a top view of another silver nitride or silver diamine fluoride delivery treatment apparatus, according to another example embodiment.

FIG. 7 is a top view of tooth tray that includes a silver nitride or silver diamine fluoride delivery treatment apparatus, according to an example embodiment.

FIG. 8 is a top view of tooth tray that includes a silver nitride or silver diamine fluoride delivery treatment apparatus, according to and example embodiment.

FIG. 9 is a flow chart for a method of using an example embodiment.

### DETAILED DESCRIPTION

All FIGS are illustrated for ease of explanation of the basic teachings of the present invention only. The extensions of the FIGs with respect to number, position, relationship and dimensions of the parts to form the preferred embodiment will be explained or will be within the ordinary skill of the art after the following description has been read and understood. Further, the exact dimensions and dimensional proportions to conform to specific force, weight, strength, and similar requirements for various applications will likewise be within the ordinary skill of the art after the following description has been read and understood.

Where used in various Figures of the drawings, the same numerals designate the same or similar parts. Furthermore, when the terms “upper,” “lower,” “right,” “left,” “forward,” “rear,” “first,” “second,” “inside,” “outside,” “front,” “back,” and similar terms are used, the terms should be understood to reference only the structure shown in the drawings and utilized only to facilitate describing the illustrated embodiments.

The Figures generally illustrate exemplary embodiments of the apparatus. The particularly illustrated embodiments of the apparatus have been chosen for ease of explanation and understanding. These illustrated embodiments are not meant to limit the scope of coverage but, instead, to assist in understanding the context of the language used in this specification and in the appended claims. Accordingly, the appended claims may encompass variations of the apparatus and methods that differ from the illustrated embodiments.

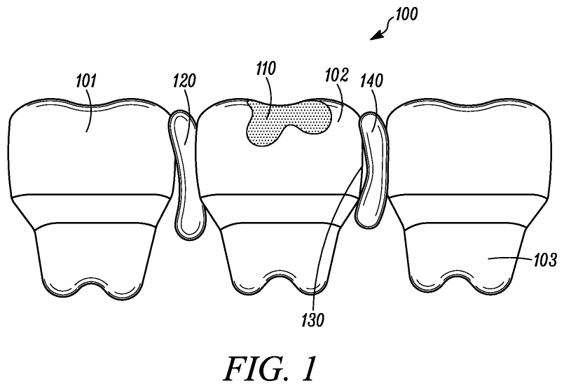

FIG. 1 is a schematic view of group 100 of several teeth 101, 102, 103. Some of are totally healthy. For example, tooth 101 has no caries or cavities. Caries and cavities are the result of tooth decay. The other teeth 102 and 103 have different types of caries or cavities. Tooth 102 includes a caries 110 on the top surface of the tooth. The tooth 102 also includes a caries 120 on one side of the tooth 102. The tooth 103 also includes a caries 130 that is on the other side of the tooth 102. Tooth 103 also includes a caries 140 the side of the tooth 103. The teeth 102 and 103 are close to one another. The caries 130 and the caries 140 are also next to one another and is located on the abutting surfaces between tooth 102 and tooth 103. Such a caries or set of caries are referred to as interproximal carries. The interstitial space between two teeth many times is difficult to clean. Cleaning generally requires flossing which may be difficult to do for a child. Adults, many times, resist flossing as it is inconvenient.

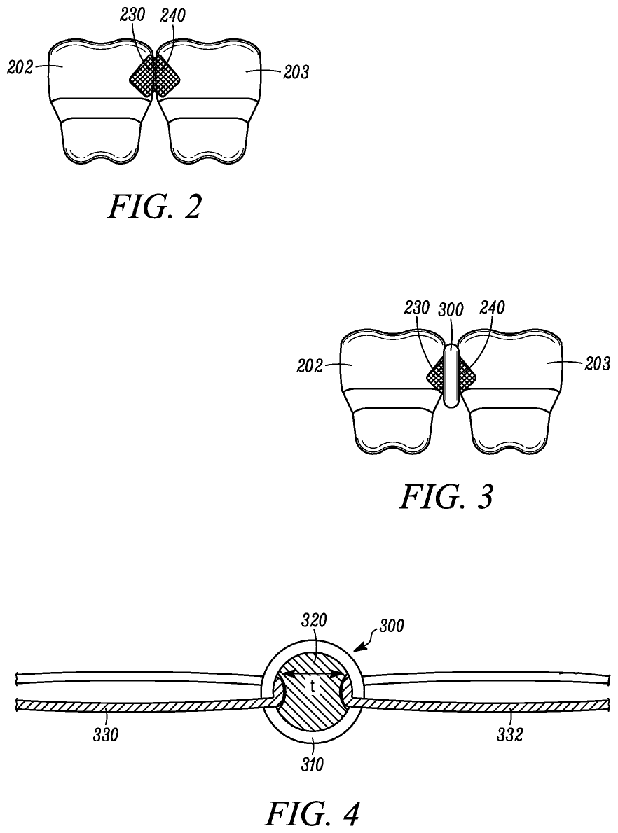

FIG. 2 is a top schematic view showing two adjacent teeth 202, 203 with an interproximal caries 230, 240 on each of the two adjacent teeth 202, 203. FIG. 3 is a top schematic view showing two teeth 202, 203 with an interproximal caries 230, 240 on each of the teeth being treated with an medicant delivery apparatus 300 which is further detailed in FIG. 4.

FIG. 4 is a schematic view of medicant delivery apparatus 300, according to an example embodiment. In this particular application, the medicant carried is a silver nitride or silver diamine fluoride treatment. The medicant delivery apparatus 300 includes a carrier 310 that is filled with an expandable fiber 320. In this particular embodiment, the carrier 310 is a non-latex dental interproximal separator. The dental separator includes the expandable fiber 320. In some embodiments, the expandable fiber 320 is attached to the carrier 310. In other embodiments, the expandable fiber 320 is merely placed in the carrier 310. Also removably attached to the carrier 310 is a first fiber extension 330 and a second fiber extension 332. In this case the fiber extensions 330, 332 are strands of dental floss. One strand of the floss 330 or 332, can be positioned between the teeth 202, 203. The floss can then be moved to place the medicant delivery apparatus 300 between the teeth 202, 203. In operation, one of the first and second fiber extensions 330, 332 is placed between the teeth 202, 203. The one fiber extension is used to pull the carrier 310 toward the space between the teeth 202, 203. The second fiber extension can be used to adjust the placement made between the teeth. The first and second fiber extensions 330, 332 can be pulled from side to side or vertically to a desired treatment position. The expandable fiber 320, in this embodiment, is impregnated with the medicant, such as SDF, before moving the carrier 310 into position. Once positioned between the teeth 202, 203, the SDF elutes out from the expandable fiber 320. The first and second fiber extensions 330, 332 can be removed by simply pulling on just one of the extensions. The fiber extensions are a loop of floss on each side. One end of the loop is pulled and the other end passes through the expandable fiber 320. Once the loops are removed the patient is being treated. The dentist can leave the medicant carriers in place for a desired amount of time. The fiber will continue to elute the medicant for a selected amount of time. Of course, the amount of medicant is not limitless and will run out after a time. The speed at which the medicant runs out can be controlled by selecting different types of expandable fiber. The rate at which the medicant elutes can also be controlled or altered by enclosing the expandable fiber 320 and placing openings in the enclosure to further slow the flow. In some embodiments, the expandable fiber 320 can come charged with the medicant. In other embodiments, the expandable fiber 320 is charged by the doctor or other dental professional.

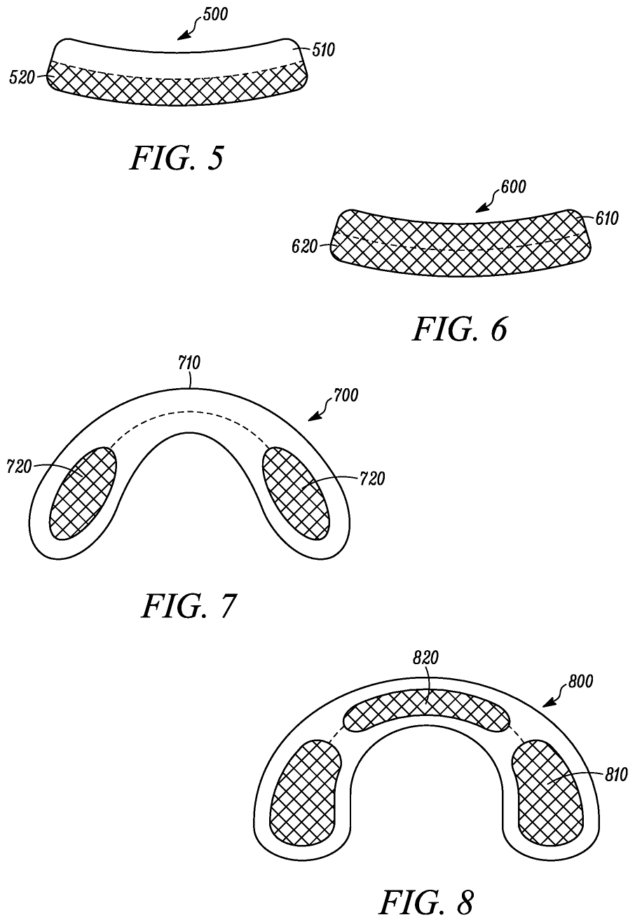

FIG. 5 is a top view of another medicant delivery apparatus 500, according to an example embodiment. In one embodiment, the medicant delivered is silver nitride or silver diamine fluoride. The medicant is delivered to a position where there is a caries or cavity in a patient's mouth as part of a dental treatment. The medicant delivery apparatus 500 includes a carrier 510 that has an expandable fiber 520 associated with the carrier 510. In this particular embodiment, the carrier 510 is a malleable, inert dental tray. The dental tray or carrier 510 includes the expandable fiber 520. The expandable fiber 520, in this particular embodiment, is attached to the carrier 510. The expandable fiber 520, in one embodiment, is produced without the medicant. In this way, the dental professional can shape the malleable tray or carrier 510 to the patient's mouth and determine where the caries is with respect to the expandable fiber 520. The professional can then place the medicant on the expandable fiber so that the medicant is directly applied to the caries or cavity. In this way, extra or excess medicant is not wasted by way of a general application of medicant, which would occur if all or a substantial portion of the expandable fiber material 520 was provided with the medicant.

Advantageously, the medicant is delivered to the spot in the mouth as needed. Furthermore, dental professionals exposure on the skin is limited as the carrier 510 and more specifically the expandable fiber 520 contains the medicant, such as SDF or silver nitride.

FIG. 6 is a top view of another medicant delivery apparatus 600, according to an example embodiment. In one embodiment, the medicant delivered is silver nitride or silver diamine fluoride. The medicant is delivered to a position where there is a caries or cavity in a patient's mouth as part of a dental treatment. The medicant delivery apparatus 600 includes a carrier 610 that has an expandable fiber 620 associated with the carrier 610. In this particular embodiment, the carrier 610 is a malleable, inert dental tray. The dental tray or carrier 610 includes the expandable fiber 620. The expandable fiber 620, in this particular embodiment, is attached to the carrier 610. The expandable fiber 620 extends to less than all of the dental tray carrier 610. This allows the dental professional to apply medicant to a more specific area, such as the outwardly facing portions of the teeth or the inwardly facing portions of the teeth. Some medicants stain. As a result, the dental professional may want, to make sure a medicant does not seep from an inwardly facing position on a tooth to a visible position on a tooth. If there is no expandable material to carry the medicant, then the staining is contained. In one embodiment, the expandable fiber is produced without the medicant. In this way, the dental professional can shape the malleable tray or carrier 610 to the patient's mouth and determine where the caries is with respect to the expandable fiber 620. The professional can then place the medicant on the expandable fiber so that the medicant is directly applied to the caries or cavity. In this way, extra or excess medicant is not wasted by way of a general application of medicant, which would occur if all or a substantial portion of the expandable fiber material 620 was provided with the medicant.

Advantageously, the medicant is delivered to the spot in the mouth as needed. Furthermore, dental professionals exposure on the skin is limited as the carrier 610 and more specifically the expandable fiber 620 contains the medicant, such as SDF or silver nitride.

FIG. 7 is a top view of still another medicant delivery apparatus 800, according to an example embodiment. In this example, a carrier 810 is a fixed dental tray. The carrier 810 includes a pair of expandable fiber or matrix portions 820, 822. In a dental treatment, the expandable fiber or matrix portions 820, 822, is impregnated with a silver nitride or silver diamine fluoride or a anhydrous gel of medicant. The medicant is delivered to a position where there is a caries or cavity in a patient's mouth as part of a dental treatment. The expandable fiber 820, 822 in this particular embodiment, is attached to the carrier 810. The expandable fiber 820, 822 extends to less than all of the dental tray carrier 810. This allows the dental professional to apply medicant to a more specific area. Some medicants stain (silver nitride or ADS). The professional can then place the medicant on the expandable fiber so that the medicant is directly applied to the caries or cavity. In this way, extra or excess medicant is not wasted by way of a general application of medicant, which would occur if all or a substantial portion of the expandable fiber material 820, 822 was provided with the medicant.

FIG. 8 is a top view of tooth tray that includes a silver nitride or silver diamine fluoride delivery treatment apparatus 800, according to an example embodiment. The carrier 810 is a fixed dental tray. The carrier 810 includes a continuous expandable fiber or matrix portion 820 that covers a majority of the surface. The treatment, in one embodiment, is to place the medicant over most of the expandable matrix portion 820. This is good for a general application of the medicant. In another embodiment, the medicant is placed at spots on the expandable matrix portion that correspond to spots where the medicant needs to be applied. The dental professional must somehow determine the area of the matrix portion 820 that will receive the medicant. A medical or dental professional places the medicant in the determined area and then places the tray into the patient's mouth. The medicant is contained in the tray during the treatment. The medicant is less likely to spill out or contact the patient since the tray contains the medicant,

In summary, an apparatus for applying a medicant includes a carrier, and a matrix of absorbent material attached to the carrier. The carrier Includes a ring dimensioned to fit in a space between two teeth, and a positioning element attached to the ring. The positioning element Includes a first string attached to a first portion of the ring, and a second string attached to a second portion of the ring. The first string and the second string are used to reposition the matrix of absorbent material to a treatment position. In one embodiment, the string is a dental floss material. The string or dental floss can be nylon or a nylon blend. The string or dental floss could also be a plastic material. The carrier can be dimensioned so that there is no excess material extending beyond the surface of the teeth when it fits between a first tooth and a second tooth. The carrier can also be provided with a tab that extends beyond the surface of a first tooth and a second tooth. The tab could be used to aid in removal of the carrier and matrix of absorbent material when the treatment time concludes. The string can include a first length of dental floss attached to a first portion of the ring and a second length of dental floss attached to a second portion of the ring.

The matrix includes a medicant. The matrix and medicant moved to an area where the medicant eludes from the matrix to treat at least one tooth. The medicant generally elutes over a treatment time. Advantageously, the apparatus can be positioned during a first visit and checked on or removed at a second visit. The time between visits will include the treatment time. The treatment time can be for hours or days or any desired time. The medicant can elute or wash out or be extracted. Saliva or a component thereof, is considered the solvent of the medicant. It is contemplated that the medicant can also be removed slowly in other ways.

The matrix includes a medicant for treating caries, in one embodiment. The matrix and medicant are moved to an area where the medicant eludes from the matrix to treat at least one dental surface. The surface can include a caries, surface cavity or cavity. The matrix can include silver nitride silver diamine fluoride, or any other medicant. The matrix can also include combinations of various medicants. The apparatus can also move the medicant using any known transport mechanism.

In some embodiments, the carrier includes dental tray. The matrix of absorbent material adjustably positioned within the dental tray. The dental tray, in one embodiment, partially covers less than all of the teeth on one level of a patient's mouth. Other types of carriers are also contemplated as being within the scope of the invention.

In operation, the apparatus is used as part of a medical or dental treatment. The dental treatment, in one embodiment, includes adding a material that will elute a medicant to a carrier, placing a medicant into the material, and moving the carrier and the material to a treatment position with respect to at least one tooth. The treatment further includes leaving the carrier and the material in the position for a sufficient amount of time to deliver a dose of the medicant. This can be for minutes, hours, or days, or for any desired treatment time sufficient to deliver a dose of the medicant to the at least one tooth. In one application, the carrier and the material are left in a position between a first tooth and a second tooth for a sufficient amount of time to deliver a dose of the medicant to at least one of the first tooth and the second tooth. In one embodiment, the material is a matrix of absorbent or adsorbent materials. The medicant includes at least one of silver diamine fluoride and silver nitride.

The dental treatment, in another embodiment, includes selecting a carrier that includes an absorbent matrix, placing a medicant on the absorbent matrix, and positioning the carrier and absorbent matrix at a treatment site proximate at least one tooth surface. The dental treatment of claim wherein the carrier includes a flexible ring. The dental treatment wherein the carrier includes a flexible ring, a dental tray or any other type of carrier.

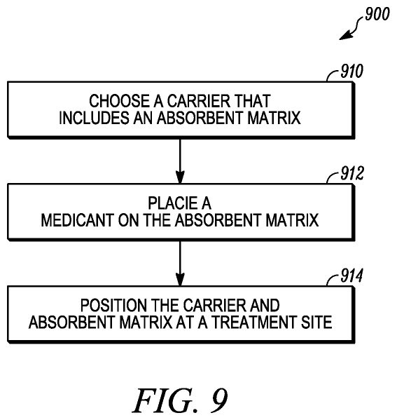

FIG. 9 is a flow chart for a method 900 of using an example embodiment. The method 900 includes choosing a carrier that includes an absorbent matrix 910, placing a medicant on the absorbent matrix 912 and positioning the carrier and absorbent matrix at a treatment site 914. In one embodiment the absorbent matrix includes a medicant. In another example embodiment, the absorbent matrix is devoid of medicant. A medical or dental professional adds the medicant to the absorbent matrix. In some embodiments, the medicant is placed at a location on the absorbent matrix that corresponds to the area where medical treatment is needed. In another embodiment, the medicant is placed over a majority of the absorbent matrix.

The foregoing discussion discloses and describes merely exemplary embodiments. Upon review of the specification, one of ordinary skill in the art will readily recognize from such discussion, and from the accompanying figures and claims, that various changes, modifications and variations can be made therein without departing from the spirit and scope of the inventions as defined in the following claims.

What is claimed:

1. An apparatus for applying a medicant comprising:
a carrier; and
a matrix of absorbent material attached to the carrier.

2. The apparatus of claim 1 wherein the carrier further comprises:
a ring dimensioned to fit in a space between two teeth; and
a positioning element attached to the ring.

3. The apparatus of claim 2 wherein the positioning element further comprises:
a first string attached to a first portion of the ring; and
a second string attached to a second portion of the ring, the first string and the second string used to reposition the matrix of absorbent material to a treatment position.

4. The apparatus of claim 2 wherein the positioning element further comprises:
a first length of dental floss attached to a first portion of the ring; and
a second length of dental floss attached to a second portion of the ring.

5. The apparatus of claim 1 wherein the matrix includes a medicant, the matrix and medicant moved to an area where the medicant elutes from the matrix to treat at least one tooth.

6. The apparatus of claim 1 wherein the matrix includes a medicant for treating caries, the matrix and medicant moved to an area where the medicant elutes from the matrix to treat at least one dental surface.

7. The apparatus of claim 1 wherein the matrix includes silver nitride.

8. The apparatus of claim 1 wherein the matrix includes silver diamine fluoride.

9. The apparatus of claim 1 wherein the carrier further comprises a dental tray, the matrix of absorbent material adjustably positioned within the dental tray.

10. The apparatus of claim 9 wherein the dental tray partially covers less than all of the teeth on one level of a patient's mouth.

11. A dental treatment comprising:
adding a material that will elute a medicant to a carrier;
placing a medicant into the material; and
moving the carrier and the material to a treatment position with respect to at least one tooth.

12. The dental treatment of claim 11 further comprising leaving the carrier and the material in the position for a sufficient amount of time to deliver a dose of the medicant.

13. The dental treatment of claim 11 further comprising leaving the carrier and the material in the position for a sufficient amount of time to deliver a dose of the medicant to the at least one tooth.

14. The dental treatment of claim 11 further comprising leaving the carrier and the material in the position between a first tooth and a second tooth fora sufficient amount of time to deliver a dose of the medicant to at least one of the first tooth and the second tooth.

15. The dental treatment of claim 11 wherein the material is a matrix.

16. The dental treatment of claim 11 wherein the medicant includes at least one of silver diamine fluoride and silver nitride.

17. A dental treatment comprising:
selecting a carrier that includes an absorbent matrix;
placing a medicant on the absorbent matrix; and
positioning the carrier and absorbent matrix at a treatment site proximate at least one tooth surface.

18. The dental treatment of claim 17 wherein the carrier is includes a flexible ring.

19. The dental treatment of claim 17 wherein the carrier is includes a dental tray.
